(19) United States
(12) Patent Application Publication
(10) Pub. No.: US 2008/0308134 A1
(43) Pub. Date: Dec. 18, 2008

(54) Substrate Processing Apparatus

(76) Inventors: Kenji Maeda, Sagamihara-shi (JP); Masaru Izawa, Tokyo (JP); Hiroyuki Kobayashi, Tokyo (JP); Kenetsu Yokogawa, Tsurugashima-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/850,154

(22) Filed: Sep. 5, 2007

(30) Foreign Application Priority Data
Jun. 14, 2007 (JP) 2007-157019

(51) Int. Cl. B08B 3/00

(52) U.S. Cl. 134/137

(57) ABSTRACT

The invention provides a substrate processing apparatus capable of removing unnecessary deposition films attached to a bevel portion of a substrate to be processed with high efficiency and at low cost without causing damage to the inner areas of the substrate to be processed having patterns formed thereto and without causing heavy metal contamination. The substrate processing apparatus comprises a rotary stage 1 on which a substrate 2 to be processed is placed having a smaller diameter than the diameter of the substrate 2, a gas supply structure unit 3 disposed above the substrate 2 to be processed for forming a gas flow for protecting a pattern formed on an upper surface of the substrate to be processed, a first gas supply system 11 for supplying nonreactive gas to the gas supply structure unit 3, an atmospheric pressure microplasma source 4 having a nozzle for supplying radicals for removing unnecessary deposits on an outer circumference portion of the substrate to be processed, a second gas supply system 14 for supplying gas to the atmospheric pressure microplasma source 4, a high frequency power supply 13 for supplying power to the atmospheric pressure microplasma source 4, and a vacuum means 5 for vacuuming and removing reaction products from the outer circumference portion of the substrate 2 to be processed.

The present application is based on and claims priority of Japanese patent application No. 2007-157019 filed on Jun. 14, 2007, the entire contents of which are hereby incorporated by reference.

### BACKGROUND OF THE INVENTION

1. Field of the Invention

The present invention relates to a substrate processing apparatus and a substrate processing method for removing unnecessary deposits attached to a rear surface or a tapered surface at the edge portion of a substrate to be processed in the process of manufacturing semiconductor devices and the like.

2. Description of the Related Art

In the manufacturing process of semiconductor devices and the like, unnecessary deposits attached to a rear surface portion or a tapered portion at the edge of a substrate to be processed (hereinafter referred to as bevel portion) during deposition steps and etching steps have caused problems. The deposits attached to the bevel portion may be detached from the bevel portion while transferring the substrate in the substrate processing apparatus for performing deposition and etching steps, while storing the processed substrate in a hoop, or while transferring the hoop. The detached deposits become the cause of particles and contamination, which are the major causes of yield deterioration.

With respect thereto, attempts have been made to prevent unnecessary deposits from attaching to the bevel portion by devising the processing chamber of the substrate processing apparatus. A plasma etching apparatus for processing insulating films is taken as an example for description. In the etching of insulating films, CF-based gases such as C₄F₈, C₅F₈ and CHF₃ are mainly used, but CFx radicals having strong deposition property generated by these gases being dissociated by plasma will reach the bevel portion and create CF-based deposition films.

One method for removing deposits composed of organic substances such as fluorocarbon on the bevel portion is proposed in Japanese Patent Application Laid-Open Publication No. 2004-200353 (patent document 1) for example, which discloses an art of supplying gases such as O₂ gas, H₂ gas and NH₃ gas capable of removing CF-based deposits while heating the rear surface at the end portion of the substrate to be processed in the etching chamber in order to remove the deposition film.

Further, a dedicated processing apparatus for removing unnecessary deposits attached to the bevel portion has been proposed. For example, paragraph 0016 of Japanese Patent Application Laid-Open Publication No. 2006-287169 (patent document 2) discloses an art of removing only the unnecessary deposits attached to the bevel portion by heating the outer circumference portion of the substrate, absorbing heat from the inner area which is at the inner side of the outer circumference portion of the substrate using a heat absorbing means disposed on the stage, and supplying reactive gas for removing unnecessary deposits to the outer circumference portion of the substrate.

The following technical problems exist in the art of removing unnecessary deposits mentioned above. That is, according to the art of patent document 1, if the effect of removing deposits of the supplied gas becomes high, the influence that the gas has on the etching characteristics of the outer circumference portion of the substrate to be processed is also increased. For example, when an O₂ gas which is most effective in removing carbon-based and CF-based deposition films is used, the resist selective ratio at the outer circumference portion of the substrate to be processed is deteriorated even if only a few ml/min of O₂ gas is supplied to the outer circumference portion of the substrate. Plasma etching is performed under a pressure in the range between sub Pa and tens of Pa, but in such a low pressure range, the gas diffusion speed is extremely fast, so that the O₂ gas supplied from the outer circumference portion of the substrate to be processed is diffused not only to the bevel portion of the substrate to be processed but also to a few cm toward the inner area than the outer circumference portion of the substrate. The O radicals having high reactivity generated by O₂ gas being dissociated by plasma reacts with the resist on the outer circumference portion, by which the resist selective ratio at the outer circumference portion is deteriorated. However, if the O₂ flow rate supplied to the outer circumference portion of the substrate to be processed is reduced in order to suppress the above phenomenon, the deposits attached to the bevel portion cannot be removed with sufficient efficiency. Therefore, it is difficult to completely remove deposits attached to the bevel portion while maintaining uniform etching property within the plane of the substrate to be processed.

The art disclosed in patent document 2 has a drawback in that the reactive gas supplied for removing deposits flow inward from the outer circumference portion of the substrate to be processed. Paragraph 0008 of patent document 2 discloses that “reaction can be suppressed even if the reactive gas is flown inward from the outer circumference portion of the substrate” by locally heating the outer circumference portion of the substrate to be processed while absorbing heat from the inner area thereof by a heat absorbing means disposed on the stage. However, depending on the type of film and the type of reactive gas, there are cases in which it is practically impossible to suppress reaction even by lowering the temperature of the inner area of the substrate to be processed.

For example, the film damage of a low dielectric constant film (low-k film) or a porous low-k film and the like used as the material of an interlayer insulating film becomes a problem. It is disclosed in FIG. 1 of Dry process symposium Mar. 1, 2004, “New ash challenges for porous low-k integration: trade-off between sidewall film modification and increase in k value” (non-patent document 1) that even when the temperature of the substrate to be processed is controlled to 15° C., the porous low-k film is somewhat altered by being subjected to processing using O₂-based gas. As can be seen from this example, even by lowering the temperature at the center portion of the substrate to be processed, the O₂-based reactive gas flowing into the inner area of the substrate to be processed causes damage to the low-k film and the porous low-k film. With respect to next generation devices in which microfabrication is further advanced, the demand to prevent damage of the low-k film becomes severe, and the flow of reactive gas toward the inner area of the substrate to be processed becomes unacceptable.

Furthermore, it is disclosed in paragraphs 0044 and 0045 of patent document 2 that a capacitively coupled plasma source is used as the method for generating reactive gas, but this is not preferable from the viewpoint of metal contamination and life of plasma source. The use of a capacitively coupled plasma source causes ions in the plasma to be incident on the electrode used for discharge, according to which the electrode material is sputtered. This may cause crucial metal contamination. Even if a solid dielectric is coated on the electrode surface so as not to cause contamination and suppress metal contamination caused by electrode sputtering, ions will be incident on the solid dielectric coating when capacitively coupled plasma source is used, inevitably consuming the dielectric and reducing the life of the plasma source significantly. Therefore, the increase of running costs caused by replacing components and deterioration of operating rates of the device are inevitable.

### SUMMARY OF THE INVENTION

The object of the present invention is to solve the above-mentioned problems in a substrate processing apparatus. Actually, the present invention aims at providing a substrate processing apparatus capable of preventing radicals having strong reactivity from spreading to the inner area of the substrate to be processed where patterns are formed, and preventing film damage at the inner area of the substrate to be processed completely.

Another object of the present invention is to provide a substrate processing apparatus capable of preventing radicals from spreading to the inner area of the substrate to be processed by forming a gas flow in the radial direction from the inner side toward the outer side of the substrate, so as to prevent radicals having strong reactivity from spreading to the inner area of the substrate to be processed where patterns are formed, and prevent film damage at the inner area of the substrate to be processed completely.

Yet another object of the present invention is to provide a substrate processing apparatus enabling significant cut down of cost related to the vacuum system, a substrate processing apparatus capable of preventing radicals from spreading to the center portion of the substrate to be processed, a substrate processing apparatus capable of cutting down cost since no major cooling equipment of the substrate to be processed is necessary, and a substrate processing apparatus capable of preventing heavy metal contamination caused by sputtering of the electrode material by plasma.

The present invention aims at solving the above-mentioned problems by providing a substrate processing apparatus for removing unnecessary substances attached to an outer circumference portion of a substrate to be processed, comprising a processing chamber for processing the substrate to be processed, a rotary stage having a smaller diameter than the diameter of the substrate to be processed on which the substrate to be processed is placed, a gas supply structure unit disposed on an upper portion of the substrate to be processed for forming a gas flow for protecting a pattern formed on an upper surface of the substrate to be processed from radicals, a first gas supply system for supplying nonreactive gas to the gas supply structure unit, an atmospheric pressure microplasma source having a nozzle for supplying radicals to the outer circumference portion of the substrate to be processed so as to remove the unnecessary substances, a second gas supply system for supplying reactive gas to the atmospheric pressure microplasma source, a high frequency power supply for supplying power to the atmospheric pressure microplasma source, and a vacuum head for vacuuming and removing reaction products from the outer circumference portion of the substrate to be processed.

Now, in the substrate processing apparatus, argon, nitrogen, oxygen, dry air or a mixed gas composed of these gases which have low reactivity and are inexpensive is supplied at a flow rate of 0.1 L/min or greater and 400 L/min or smaller to the gas supply structure unit, and a carrier gas composed of argon, helium or the like for stably generating and maintaining plasma, and oxygen, CF₄, SF₆ or a mixed gas composed of these gases which are reactive gases that react with the deposits attached to the bevel portion of the substrate are supplied to the atmospheric pressure microplasma source.

The substrate processing apparatus further characterizes in that the atmospheric pressure microplasma source utilizes a plasma source capable of electrodeless discharge, such as a high frequency inductively coupled plasma or a microwave plasma. The term “atmospheric pressure microplasma source” refers to a plasma source of a very small plasma volume of less than 100 cm³that operates under substantially atmospheric pressure, such as between 0.5 and 2 atmosphere, while on the other hand, the term “microwave plasma” refers to a plasma that utilizes a plasma excitation source frequency of 1 to 10 GHz, typically 2.45 GHz.

According to the present invention, radicals for removing deposits on the bevel portion of the substrate to be processed is generated by an atmospheric pressure microplasma source, so as to supply radicals from the sides of the bevel portion toward the bevel portion of the substrate, and at the same time, supply nonreactive gas from a gas supply structure unit at the upper portion of the substrate and evacuate reaction products and supplied gas through a vacuum head disposed below the bevel portion. At this time, by appropriately controlling the supply of flow of nonreactive gas and reactive gas, it becomes possible to form a gas flow at the upper portion of the substrate so as to prevent diffusion of radicals to the inner area of the substrate to be processed, to prevent radicals having strong reactivity from spreading to the inner area of the substrate where patterns are formed, and to prevent film damage at the inner area of the upper surface of the substrate to be processed completely.

In another example, it is possible to supply radicals from below the bevel portion and arrange the vacuum head at the side of the bevel portion. Even in this case, by appropriately controlling the supply of flow of nonreactive gas and reactive gas, it becomes possible to form a gas flow in the radial direction from the inner area toward the outer side of the substrate so as to prevent diffusion of radicals to the inner area of the substrate, to prevent diffusion of radicals having strong reactivity to the inner area of the substrate where patterns are formed, and to completely prevent film damage at the inner area of the substrate to be processed.

In addition, in a plasma reactor normally used for etching, plasma processing is performed at a reduced pressure of approximately a few Pa, so that a major vacuum equipment becomes necessary. On the other hand, an atmospheric pressure microplasma source is used according to the present invention. The operation pressure range of an atmospheric pressure microplasma source is approximately 0.5 to 2 atmosphere, so a significant cut down of cost related to the vacuum system can be realized. Moreover, since within the pressure range close to atmospheric pressure, the diffusion speed of radicals is slower by approximately 3 to 4 digits than the diffusion speed under a reduced pressure of a few Pa, so the substrate processing apparatus according to the present invention is especially preferable from the viewpoint of suppressing diffusion of radicals to the center area of the substrate to be processed.

Moreover, the present invention utilizes an inductively-coupled plasma system or a microwave plasma system capable of electrodeless discharge as the atmospheric pressure microplasma source used as the generation source of radicals. The atmospheric pressure microplasma formed by these systems are thermally nonequilibrium plasma with an electron temperature as high as 8000 to 14000° K., whereas the gas temperature is significantly low, as low as approximately 340 to 1300° K. On the other hand, the plasma is a high density plasma with an electron density of approximately le14 to le15cm⁻³. Therefore, radicals contributing to the reaction to remove deposition films can be generated highly efficiently at a gas temperature only somewhat higher than room temperature, and the deposits attached to the bevel portion can be removed at high speed. Moreover, since the gas temperature is relatively low, there is no need of a major cooling facility for the substrate, and the related costs can be cut down. Further, unlike the capacitively coupled plasma system, since there is no need for an electrode to maintain plasma, it is possible to prevent heavy metal contamination caused by sputtering of the electrode material by plasma.

According to the effects described above, the substrate processing apparatus according to the present invention can remove unnecessary deposition films attached to the bevel portion of the substrate to be processed highly efficiently and at low cost without causing film damage at the inner area of the substrate where patterns are formed and without causing heavy metal contamination.

### BRIEF DESCRIPTION OF THE DRAWINGS

FIG. 1 is a cross-sectional view showing a first embodiment of the substrate processing apparatus according to the present invention;

FIG. 2 is a cross-sectional view enlarging an edge portion of the substrate to be processed of FIG. 1;

FIG. 3 is a plan view illustrating the first embodiment of the substrate processing apparatus according to the present invention;

FIG. 4 is a cross-sectional view showing one example of an atmospheric pressure microplasma source used in the substrate processing apparatus according to the present invention;

FIG. 5 is a cross-sectional view showing yet another example of an atmospheric pressure microplasma source used in the substrate processing apparatus according to the present invention;

FIG. 6 is a plan view showing an etching apparatus utilizing the substrate processing apparatus according to the present invention as an in-line bevel deposit removal module;

FIG. 7 is a cross-sectional view showing a second embodiment of the substrate processing apparatus according to the present invention;

FIG. 8 is a plan view showing a second embodiment of the substrate processing apparatus according to the present invention;

FIG. 9 is a cross-sectional view and a plan view showing one detailed example of a gas supply structure unit; and

FIG. 10 is a cross-sectional view and a plan view showing yet another detailed example of the gas supply structure unit.

### DETAILED DESCRIPTION OF THE PREFERRED EMBODIMENTS

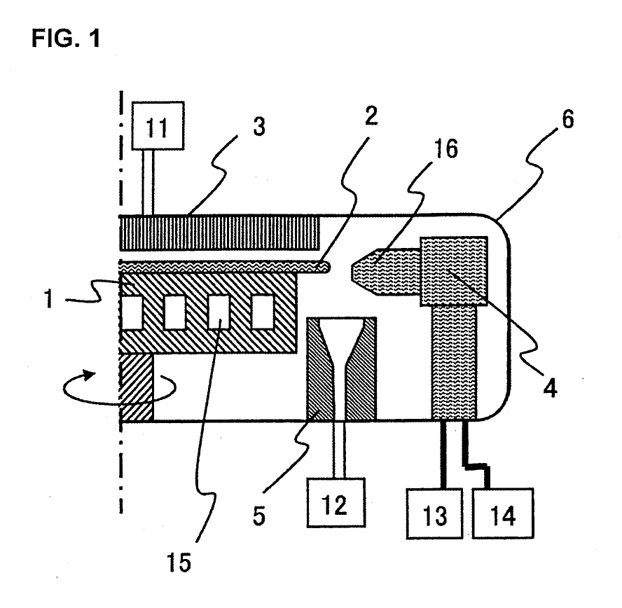

A first preferred embodiment of the present invention will be described with reference to FIGS. 1 through 4 and FIGS. 9 and 10. FIG. 1 is a cross-sectional view showing the outline of a structure of a substrate processing apparatus according to the present invention. FIG. 1 illustrates a right half of a cross-section of a substrate processing apparatus. The substrate processing apparatus according to the present invention is composed of a processing chamber 6, a rotary stage 1 for mounting a substrate 2 to be processed, a gas supply structure unit 3 for forming a gas flow to protect a pattern formed on an upper surface of the substrate to be processed, a first gas supply system 11 for supplying nonreactive gas to the gas supply structure unit 3, a plasma head 4 for generating atmospheric pressure plasma, a power supply system 13 for supplying power to the plasma head 4, a second gas supply system 14 for supplying gas to the plasma head 4, a vacuum head 5 for evacuating and removing reaction products from the supplied gas and from the outer circumference portion of the substrate to be processed, a vacuum system 12 for vacuuming the vacuum head 5, and a nozzle 16 for supplying radicals of plasma generated by the plasma head 4 to the outer circumference portion of the substrate 2 to be processed. The plasma head 4 and the nozzle 16 constitute an atmospheric pressure microplasma source.

The rotary stage 1 has a diameter smaller by approximately 1 to 60 mm than the substrate to be processed, preferably approximately 2 to 20 mm smaller, and is equipped with a temperature control mechanism 15, a chucking mechanism (not shown) of the substrate to be processed, and a substrate elevating mechanism (not shown) for moving the substrate to be processed up and down during transfer. The chucking mechanism can adopt any type of mechanism, such as a vacuum chuck for supporting the substrate by reducing the pressure at the rear surface of the substrate than the pressure of the processing chamber 6, or a bipolar electrostatic chuck. Further, the temperature control mechanism can adopt any type of mechanism, such as a system recycling a temperature-controlled coolant, or a system utilizing a peltiert device. Moreover, the rotary stage can be rotated at an arbitrary rotation speed of approximately 0.5 to 240 rotations per minute, preferably approximately 1 to 60 rotations per minute, via a driving mechanism such as a motor.

A gas supply structure unit 3 is disposed above the rotary stage 1. The gas supply structure unit takes the role to supply the gas supplied through the first gas supply system 11 to the substrate surface. The gas supplied through the gas supply structure unit 3 forms a gas flow toward the outer radial direction between the surface of the substrate to be processed and the gas supply structure unit. This gas flow prevents the radicals supplied to a bevel portion of the substrate to be processed from spreading to the inner area of the substrate where patterns are formed and prevents the occurrence of film damage.

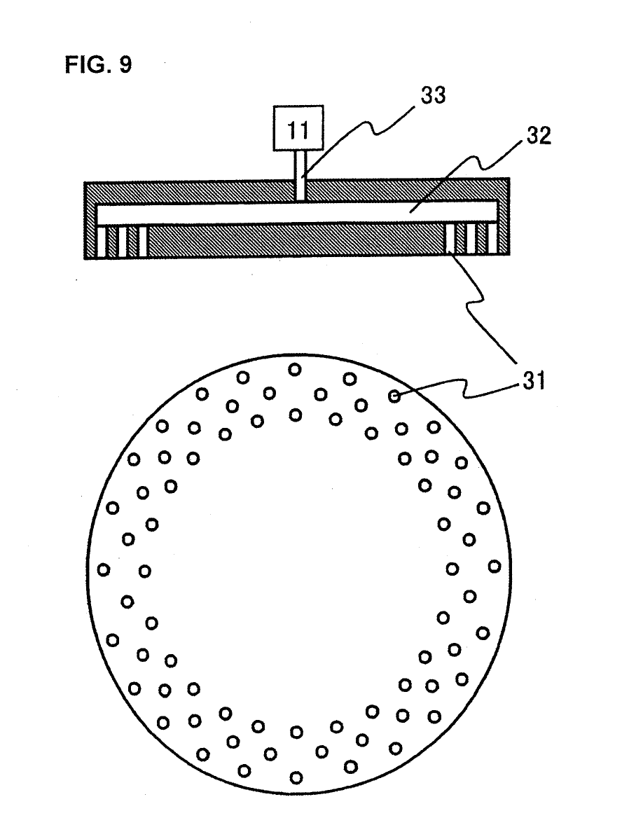

Next, the structure of the gas supply structure unit will be described with reference to FIG. 9. The gas supply structure unit 3 is made of aluminum or aluminum having its surface subjected to alumite (anodized aluminum) treatment, and has a substantially disk-like shape. Further, tens to hundreds of gas holes 31 with a diameter of 0.2 to 3.0 mm, preferably between 0.4 and 2.0 mm, are formed on a bottom surface thereof. A buffer chamber 32 for ejecting gas in a uniform manner through the gas holes 31 is formed inside the gas supply structure unit, and the buffer chamber is connected via a gas supply port 33 to the first gas supply system 11. The gas holes 31 are arranged at the outer circumference portion of the gas supply structure unit at substantially uniform pitches of approximately 2 to 50 mm, preferably between 5 and 20 mm. The gas holes can be arranged uniformly throughout the whole surface of the gas supply structure unit, but by arranging the holes collectively at only the outer circumference portion of the gas supply structure unit, the effect of preventing radicals from spreading to the inner area of the substrate to be processed is further improved.

The gas supplied through the gas supply structure unit 3 should preferably be inexpensive gas that does not easily react with the patterns and films formed on the substrate surface, such as argon, nitrogen, oxygen, dry air, or a mixed gas composed of such gases having little reactivity and is inexpensive. When using dry air, the occurrence of corrosion and particles caused by moisture adhering to the substrate 2 to be processed can be prevented by setting the dew point of the dry air to below 0° C., preferably below −30° C. Further, since the oxygen gas will not turn into radicals unless they contact plasma, it will not cause damage to the film disposed at the center area of the substrate to be processed where patterns are formed.

Furthermore, the effect of preventing diffusion of radicals becomes higher as the gas flow supplied through the gas supply structure unit 3 increases, but if the gas flow becomes too high, the running cost is increased. Therefore, the flow rate of gas supplied through the gas supply structure unit 3 should preferably be around 0.1 to 400 L/min, preferably between 0.5 and 200 L/min.

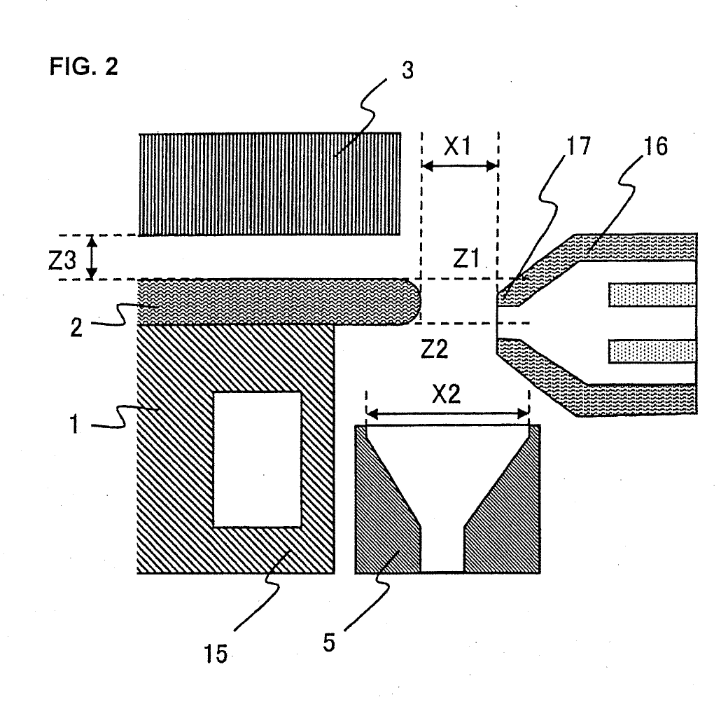

Furthermore, the lower surface of the gas supply structure unit 3 and the upper surface of the substrate 2 to be processed is substantially parallel, and the distance between the surfaces (denoted by Z3 of FIG. 2) is set to approximately 2 to 100 mm, preferably between 5 and 50 mm, that is, as narrow as possible within the range enabling transfer of the substrate 2 to be processed. This is because by minimizing the distance between the gas supply structure unit 3 and the substrate 2 to be processed, the speed of flow of gas supplied through the gas supply structure unit 3 over the substrate 2 to be processed is increased, by which the effect of preventing diffusion of radicals to the center area of the substrate to be processed is even further improved.

The base material of the gas supply structure unit 3 according to the present embodiment is aluminum from the viewpoint of workability, contamination and cost, but any material can be used as long as the material does not cause contamination of the substrate, can be processed easily, and can be manufactured at low cost, such as quartz, easy-cutting ceramics and synthetic resin.

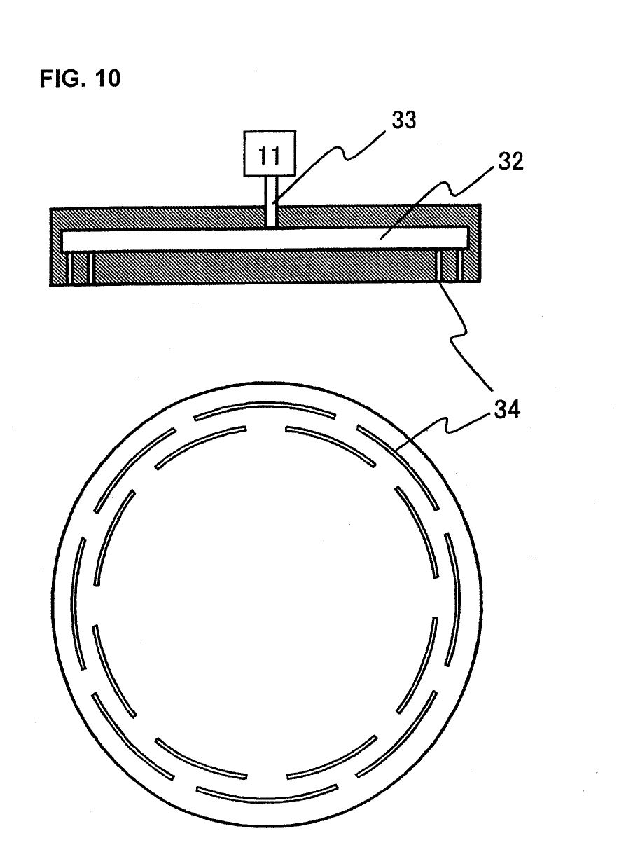

Next, another structure of the gas supply structure unit will be described with reference to FIG. 10. Description of portions that overlap with the description of FIG. 9 will be omitted. In the gas supply structure unit illustrated in FIG. 9, gas holes 31 are formed on the lower surface thereof, but on the other hand, according to the gas supply structure unit illustrated in FIG. 10, multiple slit-like gas supply ports 34 are formed on the lower surface thereof. As shown in FIG. 10, the slit-like gas supply ports 34 are arranged so that eight slits are formed at the outermost circumference of the gas supply structure unit and eight slits are formed in staggered manner at the inner side thereof. This arrangement enables to form an air-curtain-like gas flow at the outer circumference portion of the substrate to be processed. Thus, the radicals supplied to the bevel portion of the substrate to be processed are prevented from spreading toward the inner area of the substrate to be processed where patterns are formed, and the occurrence of film damage can be prevented. In FIG. 10, two rows of eight ports are arranged as the slit-like gas supply ports 34, but there is no limitation to the number and rows of slit-like gas supply ports according to the present invention. Further, the slit-like gas supply ports 34 have a substantially arced shape in FIG. 10, but they can have a linear shape instead.

Next, with reference again to FIG. 1, the structure for supplying radicals having high reactivity to the bevel portion in order to remove the deposition film attached to the bevel portion will now be described. As illustrated in FIG. 1, a plasma head 4 is disposed at the outer side of the rotary stage 1. The plasma head is connected to a second gas supply system 14 for supplying reactive gas and a power supply system 13 for applying high frequency power thereto. Further, a nozzle 16 is provided on the plasma head 4. By applying high frequency power to the reactive gas supplied through the second gas supply system 14 to inject the radicals generated by turning reactive gas into plasma through the nozzle 16 to the bevel portion of the substrate 2 to be processed, it becomes possible to remove the deposits attached to the bevel portion.

As illustrated in FIG. 2, an extremely small opening 17 with a diameter of approximately 0.1 to 10 mm, preferably between 0.3 and 3 mm, is formed to the nozzle 16 so as to allow radicals to be provided efficiently only to the bevel portion of the substrate 2 to be processed. Further, by arranging the upper end of the nozzle opening portion 17 to be lower than the upper surface Z1 of the substrate to be processed and higher than the lower surface Z2 of the substrate to be processed, the radicals can be supplied even more efficiently to the bevel portion. Moreover, the distance X1 from the leading end of the nozzle 16 to the outermost circumference portion of the substrate 2 to be processed should preferably be 0.2 mm or greater and 50 mm or smaller. If the distance to the substrate to be processed is smaller than 0.2 mm, the risk of the leading end of the nozzle coming into contact with the substrate to be processed is increased, and if the distance is greater than 50 mm, the supply efficiency of radicals is deteriorated.

A vacuum head 5 having an opening formed to the upper portion thereof is disposed below the nozzle 16. Here, the width X2 of the opening is approximately 5 to 100 mm, which is evacuated by a vacuum system 12. The gas supplied through the gas supply structure unit 3, the radicals ejected toward the bevel portion through the nozzle 16 and the reaction products generated by the reaction between the radicals and the deposits on the bevel portion are evacuated to the exterior of the processing chamber through the vacuum head 5 and the vacuum system 12. Thus, even when a large number of substrates are processed, it becomes possible to prevent the occurrence of particles generated by reaction products being reattached and detached from the interior of the processing chamber.

Since the substrate processing apparatus of the present invention utilizes an atmospheric pressure microplasma source, it can be used at a pressure of approximately 0.5 to 2 atmosphere. Therefore, the vacuum system 12 can utilize a vacuum pump used in a normal plasma processing apparatus, but it is more cost-effective to use a propeller fan, a turbo fan, a sirocco fan or the like. Moreover, since radicals have a slow diffusion speed in atmospheric pressure, when an atmospheric pressure microplasma source is used, the radicals supplied to the bevel portion can be prevented from spreading toward the center area of the surface of the substrate 2 to be processed.

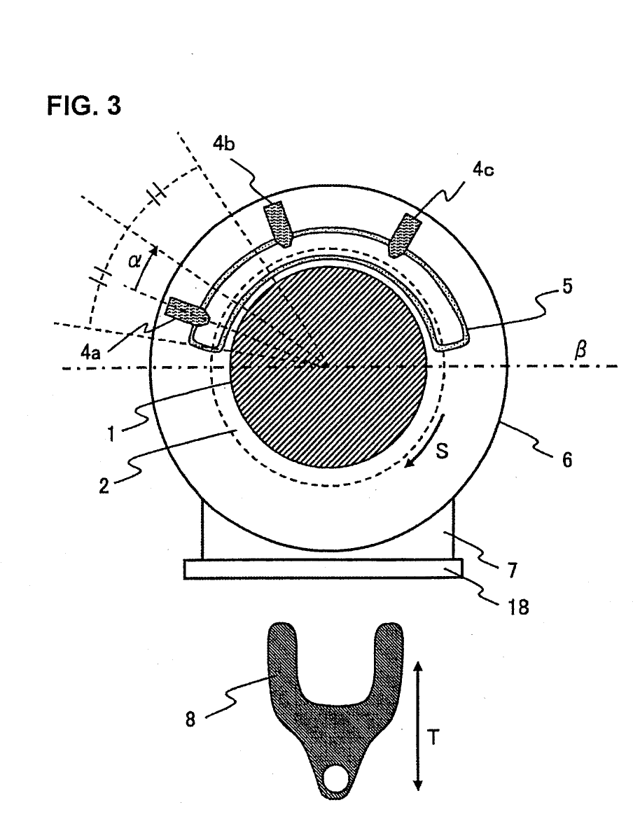

FIG. 3 is a plan view showing the outline of the structure of the substrate processing apparatus according to the present invention. The circle drawn by the dashed line in the drawing shows the outermost circumference of the substrate 2 to be processed, the arrow S in the drawing shows the direction of rotation of the stage 1, and the arrow T shows the direction of movement of the transfer arm 8. An opening with a sufficient width and height to allow the substrate 2 to be processed and the transfer arm 8 to pass therethrough is provided on the side wall of the substantially cylindrical processing chamber 6, and a transfer port 7 and a gate valve 18 are provided on the opening. On the opposite side of the transfer port are provided the vacuum head 5 and multiple plasma heads 4a through 4c.

Each plasma head 4a through 4c is respectively and independently connected to a reactive gas supply system (not shown) and a power supply system (not shown). By arranging multiple plasma heads 4, the processing speed is not only increased, but by providing different reactive gases to the multiple plasma heads 4, it becomes possible to correspond to cases in which the deposition film adhered to the substrate 2 to be processed is a layered structure composed of various films. Further, by sharing the gas supply system and the power supply system connected to the plasma heads 4a through 4c, the processing speed can be improved while cutting down costs. The number of plasma heads in FIG. 3 is three, but this number is a mere example. The present invention functions with at least one plasma head, but by providing three or more plasma heads, further improvement of processing speed can be expected.

The vacuum head 5 is disposed below the aforementioned plasma head 4. As illustrated in FIG. 3, the opening of the vacuum head 5 is in the shape of a semi-circular arc facing the bevel portion of the substrate 2 to be processed. As described, the width of the opening of the vacuum head 5 is within the range of 5 to 100 mm. Further, as shown in FIG. 3, the vacuum head 5 can be disposed in a somewhat offset manner from the plasma head 4 for about angle a degrees toward the lower stream side of the direction of rotation of the substrate 2 to be processed. Thereby, even when the substrate to be processed is rotated in the arrow S direction, the reaction products from the substrate 2 to be processed or radicals not used for reaction can be vacuumed efficiently. In FIG. 3, the vacuum head 5 is extended downstream than the plasma head 4c, according to which the reacted gas can be vacuumed efficiently from the upper surface of the substrate 2 to be processed.

The offset angle α can be selected appropriately from angles between 0 degrees and 45 degrees according to the number of plasma heads 4 being disposed.

Moreover, one or all the plurality of plasma heads 4a through 4c in FIG. 3 are disposed opposite from the transfer port 7 and the gate valve 18 with respect to a plane passing the center axis of the substrate 2 to be processed and substantially parallel with the gate valve 18, that is, a plane shown by the dashed-dotted line β in the drawing. This structure enables to prevent the transfer arm and the plasma head from interfering with the substrate to be processed when transferring the substrate. This structure enables to minimize the distance between the gas supply structure unit 3 and the substrate 2 to be processed (Z3 in FIG. 2), and to further enhance the effect of preventing diffusion of radicals on the substrate to be processed.

On the other hand, if the plasma head 4 is disposed on the same side as the transfer port, the height of the transfer surface must be set at a higher position than the plasma head 4 in order to prevent contact of the plasma head and the substrate to be processed. This is not preferable from the viewpoint of radical diffusion, since it means that the distance between the gas supply structure unit 3 and the substrate 2 to be processed (Z3 in FIG. 2) is increased. Furthermore, since the stroke of the elevating mechanism of the substrate to be processed provided on the rotation stage 1 is enlarged, it leads to the increase in cost of the elevating mechanism.

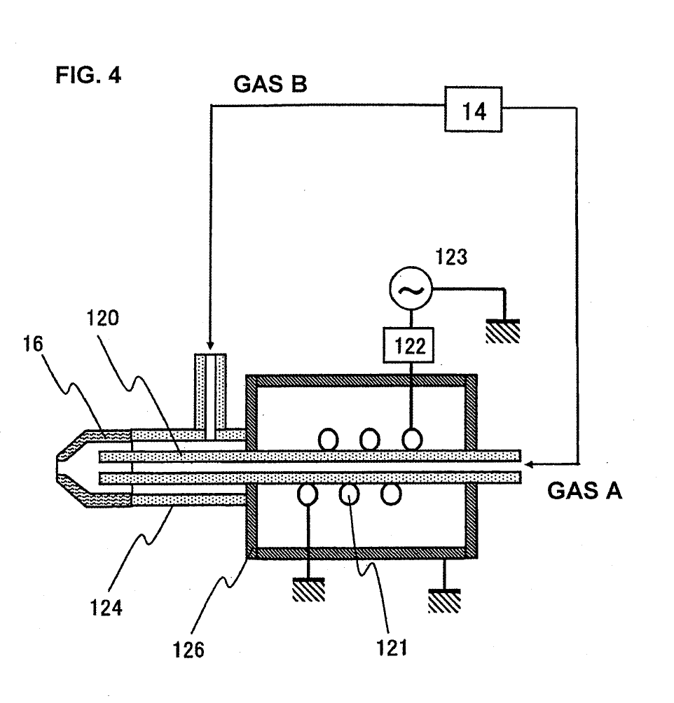

Next, FIG. 4 is a cross-sectional view illustrating the outline of the structure of an atmospheric pressure microplasma source composed of a plasma-head 4 and a nozzle 16. The plasma head 4 functions to turn reactive gas supplied through a second gas supply system 14 under an atmospheric pressure of approximately 0.5 to 2 atmosphere. One example will now be described taking an inductively-coupled plasma source as an example.

First, a coil-type inductive antenna 121 with a number of turns selected from 1 to 10 turns is wound around the outer side of a first insulator pipe 120 having an inner diameter of approximately 0.5 to 4 mm. One side of the antenna 121 is connected to a high frequency power supply 123 via a matching network 122, and the other side is connected to an earth. The matching network 122 and the high frequency power supply 123 correspond to the aforementioned power supply system 13. Moreover, a grounded metallic high frequency shield 126 is arranged so as to surround the inductive antenna portion. The aforementioned first insulating pipe 120 is protruded for approximately 10 to 50 mm from the high frequency shield to the substrate to be processed.

A second insulating pipe 124 is disposed coaxially with the first insulating pipe 120 on the outer circumference portion of the aforementioned projection. Further, an insulating nozzle 16 is disposed on the second insulating pipe 124. The nozzle has an extremely small opening with a diameter as small as approximately 0.3 to 3 mm disposed toward the substrate to be processed. The material for forming such insulating pipe and insulating nozzle should preferably have resistance to plasma and radicals and should cause little contamination, such as quartz, alumina ceramics and heat-resistant glass.

Gas A is supplied from the second gas supply system 14 to the first insulating pipe 120, and gas B is supplied to the second insulating pipe 124. Gas A is turned in to plasma by the inductive electric field generated by the inductive antenna 121. Gas A is a carrier gas capable of generating and maintaining atmospheric pressure microplasma such as argon, helium or a mixed gas composed thereof, and gas B is a reactive gas capable of removing the deposits attached to the bevel portion such as oxygen, CF₄, SF₆or a mixed gas composed thereof. Reactive gas B generates radicals having strong reactivity by mixing with gas A having turned into plasma in nozzle portion 16.

Thus, by providing an arrangement to supply only the carrier gas to the plasma generating portion and mixing the reactive gas at a lower stream portion, it becomes possible to generate and maintain an atmospheric pressure microplasma stably under a wide range of conditions. Moreover, though the inner wall of the first insulating pipe 120 near the inductive antenna is easily worn by direct contact with high density plasma, since reactive gas is not supplied thereto, the life of the first insulating pipe 120 is extended, and as a result, the life of the whole atmospheric pressure microplasma source can be extended.

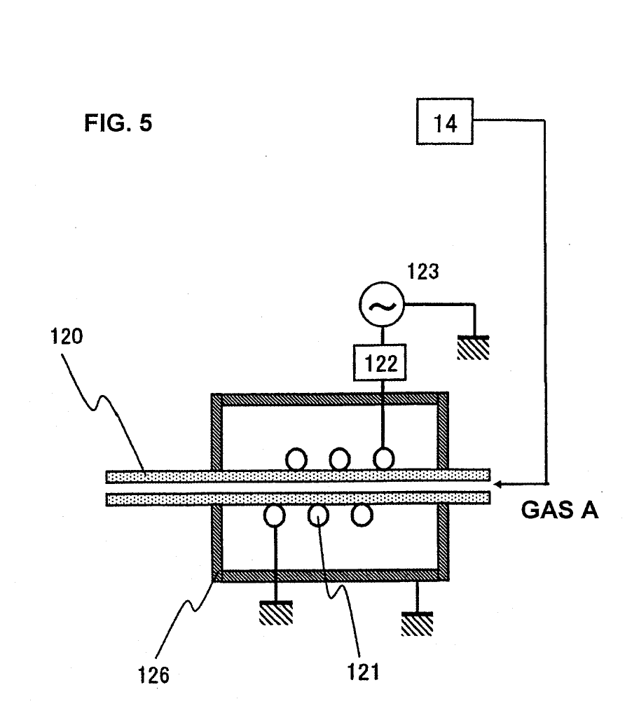

Other than the gas supply method described above, it is possible to mix the carrier gas and the reactive gas and to supply the same. In this case, as shown in FIG. 5, the structure of the plasma head itself can be simplified, so it is more advantageous cost wise.

In other words, according to the present embodiment, a coil-like inductive antenna 121 having one to ten turns is wound on the outer side of the first insulating pipe 120 of the plasma head 4. One side of the antenna 121 is connected to a high frequency power supply 123 via a matching network 122, and the other side is connected to an earth. The matching network 122 and the high frequency power supply 123 correspond to the power supply system 13. Further, a grounded metallic high frequency shield 126 is disposed so as to surround the inductive antenna portion. The first insulating pipe 120 is protruded for 10 to 50 mm from the high frequency shield to the substrate to be processed. The first insulating pipe 120 is supplied with a mixed gas A composed of a carrier gas such as argon and helium capable of generating and maintaining atmospheric pressure microplasma and a reactive gas capable of removing deposits adhered to the bevel portion, which is turned into plasma to generate radicals having strong reactivity.

The frequency for turning gas A into plasma, that is, the frequency of the high frequency poser supply 123, should preferably be in the VHF band or the UHF band of approximately 30 MHz to 3 GHz. In many cases, the inductively coupled plasma is generally excited by a commercial frequency of 13.56 MHz, but according to the atmospheric microplasma source, the antenna and the like is reduced in size, so the plasma generation efficiency can be improved by utilizing electromagnetic waves having shorter wavelengths.

FIGS. 4 and 5 have been referred to in describing the embodiment of the plasma head 4 taking an inductively coupled plasma source as an example, but the present invention is not restricted in anyway to these examples. Any type of atmospheric pressure microplasma source capable of realizing electrodeless discharge can be utilized, such as an inductively coupled plasma source, various microwave plasma sources and plasma sources utilizing dielectric barrier discharge.

The atmospheric microplasma generated by these methods is thermally nonequilibrium plasma, characterized in that the electron temperature is as high as 8000 to 14000° K. whereas the gas temperature is significantly low, approximately between 340 and 1300° K. On the other hand, the plasma is a high density plasma with an electron density of approximately le14 to le15 cm⁻³. Therefore, it becomes possible to effectively generate radicals contributing to the reaction of removing the deposition film deposited on the bevel portion of the substrate 2 to be processed at a gas temperature somewhat higher than room temperature, so as to remove deposits attached to the bevel portion speedily.

Moreover, since the gas temperature is relatively low, there is no need of a major cooling equipment of the substrate to be processed, and the costs can be cut down. According to the present embodiment, the rotary stage 1 has a temperature control mechanism 15, but some types of substrates do not require a temperature control mechanism. In such case, the related costs can be cut down significantly.

Next, the operation of the substrate processing apparatus according to the present invention will be described. At first, the gate valve 18 is opened, and the transfer arm 8 carries the substrate 2 to be processed onto the rotary stage 1. Next, the substrate elevating mechanism (not shown) provided on the stage 1 pushes up the substrate 2 to be processed. Next, the transfer arm 8 is returned to the exterior of the processing chamber, the gate valve 18 is closed and the substrate elevating mechanism is lowered to place the substrate 2 to be processed on the rotary stage 1.

Next, the substrate to be processed is fixed to the rotary stage 1 via a chucking mechanism (not shown), and then the rotary stage is rotated at a given speed. Next, nonreactive gas is supplied to the processing chamber from the gas supply structure unit 3. Thereafter, reactive gas is supplied to the plasma head 4, and then high frequency power is supplied to the plasma head from the power supply system. Thus, reactive gas is turned into plasma, injected toward the bevel portion of the substrate 2 to be processed and starts removing unnecessary deposition film attached to the bevel portion.

After sufficient time has elapsed to remove the unnecessary deposition film from the whole circumference of the bevel portion of the substrate 2 to be processed, the power supplied to the plasma head 4 is stopped, and then, the supply of reactive gas is stopped. Thereafter, the rotation of the rotary stage 1 is stopped, and the supply of nonreactive gas from the gas supply structure unit 3 is stopped.

Next, the chucking mechanism is turned off, and the substrate 2 to be processed is pushed up by the substrate elevating mechanism while the gate valve 18 is being opened. Finally, the transfer arm 8 is moved above the rotary stage 1, the substrate elevating mechanism is lowered, the transfer arm 8 and the substrate 2 are moved to the exterior of the processing chamber, and then the gate valve 18 is closed to complete the process.

One of the characteristics of the present invention is that the vacuum system 12 is constantly activated during operation of the substrate processing apparatus according to the present invention described above. By activating the vacuum system 12 even during transfer of the substrate 2 to be processed, that is, even when the gate valve 18 is opened, the pressure within the processing chamber 6 can be maintained at a somewhat negative pressure than the atmospheric transfer chamber. Thus, a gas flow from the atmospheric transfer chamber toward the processing chamber 6 is created, preventing particles from attaching to the substrate 2 to be processed during transfer. In addition thereto, while transferring the substrate 2 to be processed, a nonreactive gas is supplied for approximately 0.01 to 1 L/min from the gas supply structure unit 3, so that when the vacuum system 12 is activated to maintain the pressure within the processing chamber 6 somewhat negative than the atmospheric transfer chamber, the effect of preventing particles from attaching to the substrate 2 during transfer thereof can be further enhanced.

By using the substrate processing apparatus according to the present invention described with reference to FIGS. 1 through 5, the unnecessary deposition film attached to the bevel portion of the substrate 2 to be processed can be removed highly efficiently and inexpensively without causing film damage to the inner area of the substrate 2 to be processed where patterns are formed and without causing heavy metal contamination.

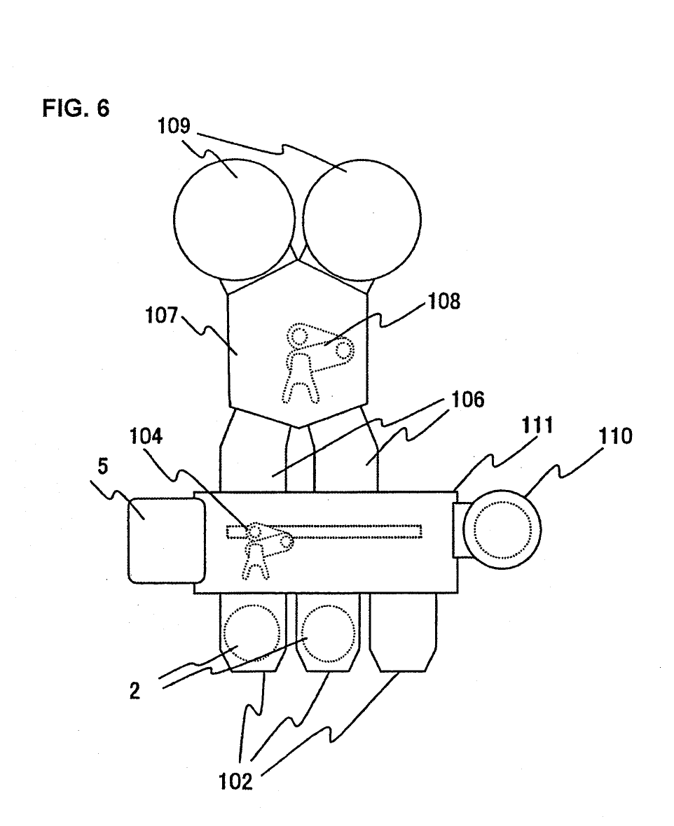

The substrate processing apparatus according to the present invention can be used as a stand-alone processing apparatus, but it can also be equipped on an etching apparatus or a CVD (chemical vapor deposition) device as an in-line bevel deposit removal module. Now, with reference to FIG. 6, the method for processing unnecessary deposits attached to the bevel portion using an in-line system will be described. The substrate processing apparatus according to the present invention is installed as a bevel deposition removal module 110 in an atmospheric transfer chamber 111 of FIG. 6.

At first, a hoop 102 storing a plurality of substrates 2 to be processed is disposed in the atmospheric transfer chamber 111 of a semiconductor etching apparatus as shown in FIG. 6. The processing apparatus in the present example is a semiconductor etching apparatus, but this is a mere example, and any other apparatus such as a CVD apparatus can be used.

The substrate 2 to be processed stored in the hoop 102 is taken out of the hoop by an atmospheric transfer arm 104 and mounted on an aligner 105. The aligner functions to fine-adjust the position of the substrate within a horizontal plane and to determine the circumferential position of the substrate.

The substrate 2 to be processed having its position and orientation adjusted by the aligner is carried into a lock chamber 106. Then, the lock chamber is evacuated by a pump not shown, and the substrate 2 to be processed is carried into a buffer chamber 107 by a vacuum transfer arm 108.

Thereafter, the substrate 2 to be processed is carried into a plasma processing chamber 109, where it is subjected to a predetermined etching process. At this time, unnecessary deposition film is attached to the bevel portion of the substrate 2 to be processed.

Next, the substrate 2 to be processed is carried out of the processing chamber 109 by the vacuum transfer arm 108 and transferred to the lock chamber 106. Next, the lock chamber is purged by nitrogen gas or dry air. After the pressure within the lock chamber is raised to atmospheric pressure, the processing substrate 2 is carried out of the lock chamber by the atmospheric transfer arm 104, and transferred via the atmospheric transfer chamber 111 into the bevel deposit removal module 110. Next, after removing the unnecessary film deposited on the bevel portion by the procedure described earlier, the substrate to be processed is retrieved in the hoop 102.

All the processes to the substrate is completed by the procedure described up to now, so after all the substrates 2 to be processed are retrieved in the hoop 102, the hoop 102 is collected from the etching apparatus.

The in-line processing of unnecessary film deposited on the bevel portion is advantageous compared to using a stand-alone bevel deposition removal apparatus from viewpoints of both throughput and cost. Moreover, since no substrate having bevel deposits attached thereto is brought into the hoop, the risk of bevel deposits being detached in the hoop and generating particles and the risk of cross contamination can be reduced.

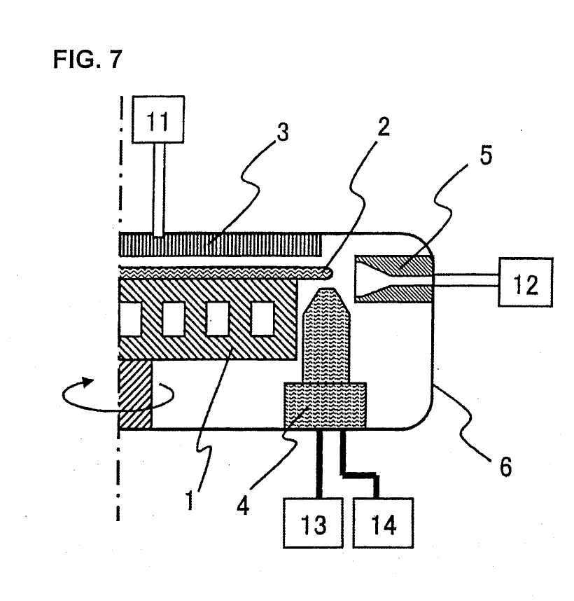

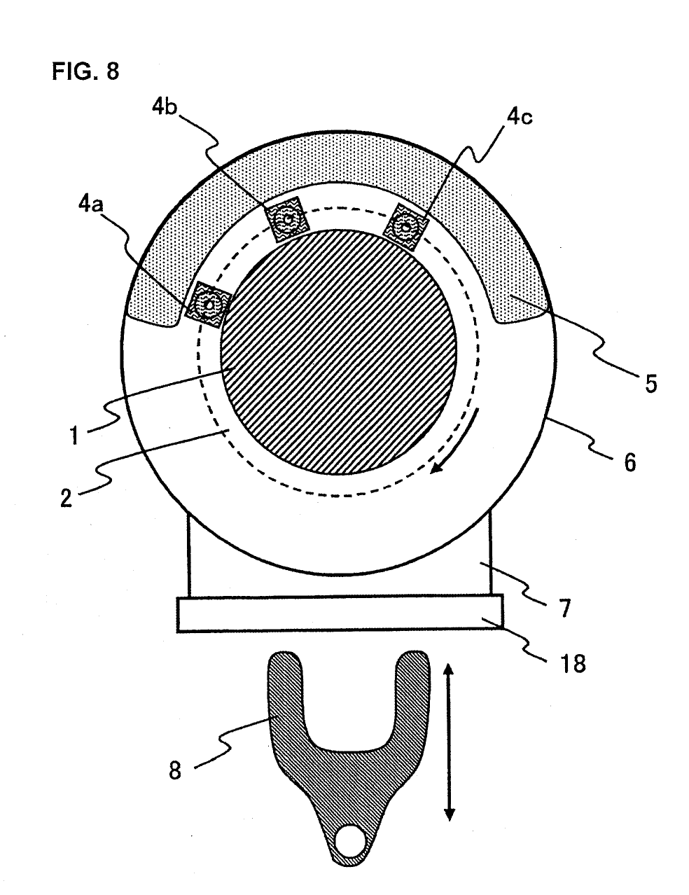

Next, with reference to FIGS. 7 and 8, the second embodiment of the present invention will now be described. The descriptions of portions that overlap with those of embodiment 1 are omitted.

According to the second embodiment of the present invention illustrated in FIG. 7, a plasma head 4 for generating radicals is positioned below the bevel portion of the substrate 2 to be processed, through which radicals are injected toward the upper direction. Moreover, a gas supply structure unit 3 is disposed on the upper portion of the substrate 2 to be processed, and nonreactive gas is supplied onto the substrate 2 to be processed through a first gas supply system 11. Further, a vacuum head 5 is positioned on the outer side portion of the bevel portion of the substrate 2 to be processed and arranged so that its opening faces the bevel portion of the substrate 2. Moreover, as shown in FIG. 8, the vacuum head 5 has a circular arc-like shape disposed along the outer circumference portion of the substrate 2 to be processed mounted on the rotary stage 1.

Also according to the arrangement of the present embodiment, a gas flow in the radial direction from the inner side of the substrate to be processed toward the outer side thereof can be created so as to suppress diffusion of radicals toward the inner area of the substrate 2 to be processed by vacuuming reaction products, radicals and unreacive gas through the vacuum head 5. Therefore, it becomes possible to prevent radicals having strong reactivity from spreading toward the inner area of the substrate 2 where patterns are formed, and to suppress film damage at the inner area of the substrate completely.

The removal process of deposits on the bevel portion formed every time an insulating film is etched has been described according to the above description, but the present invention is not restricted thereto, and can be used to remove deposits on bevel portions of substrates in various processes performed in a semiconductor processing apparatus.

1. A bevel deposition removal apparatus for removing unnecessary substances attached to an outer circumference portion of a substrate to be processed, comprising:
a processing chamber for removing unnecessary substances attached to the outer circumference portion of the substrate to be processed;
a rotary stage on which the substrate to be processed is placed having a smaller diameter than the diameter of the substrate to be processed;
a gas supply structure unit disposed on an upper portion of the substrate to be processed for forming a gas flow for protecting a pattern formed on an upper surface of the substrate to be processed from radicals;
a first gas supply system for supplying nonreactive gas to the gas supply structure unit;
an atmospheric pressure microplasma source for supplying radicals for removing the unnecessary substances to the outer circumference portion of the substrate to be processed;
a second gas supply system for supplying reactive gas to the atmospheric pressure microplasma source;
a high frequency power supply for supplying power to the atmospheric pressure microplasma source; and
a vacuum head for vacuuming and removing reaction products from the outer circumference portion of the substrate to be processed.

2. The bevel deposition removal apparatus according to claim 1, wherein
the atmospheric pressure microplasma source and the vacuum head are disposed on an opposite side in the processing chamber from an opening for transferring the substrate to be processed.

3. The bevel deposition removal apparatus according to claim 1, wherein
the distance between a lower surface of the gas supply structure unit and the upper surface of the substrate to be processed is 2 mm or greater and 100 mm or smaller.

4. The bevel deposition removal apparatus according to claim 1, wherein
argon, nitrogen, oxygen, dry air or a mixed gas composed of these gases is supplied at a flow rate of 0.1 L/min or greater and 400 L/min or smaller to the gas supply structure unit.

5. The bevel deposition removal apparatus according to claim 1, wherein
a carrier gas composed of argon, helium or a mixed gas of argon and helium is supplied to a plasma generating unit of the atmospheric pressure microplasma source, and oxygen, CF₄, SF₆ or a mixed gas composed of these gases is supplied to a downstream portion from the plasma generating unit.

6. The bevel deposition removal apparatus according to claim 1, wherein
the atmospheric pressure microplasma source has a nozzle for supplying radicals to the outer circumference portion of the substrate to be processed;
an upper end of an opening of the nozzle is positioned lower than the upper surface and higher than a rear surface of the substrate to be processed; and
the vacuum head is positioned below an end portion of the substrate to be processed.

7. The bevel deposition removal apparatus according to claim 1, wherein
a nozzle of the atmospheric pressure microplasma source is positioned below an end portion of the substrate to be processed; and
the vacuum head is positioned at a side of the outer circumference portion of the substrate to be processed.

8. The bevel deposition removal apparatus according to claim 1, wherein
the vacuum head is positioned below an opening of a nozzle portion of the atmospheric pressure microplasma source, and arranged in a circular arc from an upper stream side toward a lower stream side of the direction of rotation of the rotary stage along the outer circumference portion of the substrate to be processed placed on the rotary stage.

9. A bevel deposition removal apparatus for removing unnecessary substances attached to an outer circumference portion of a substrate to be processed, comprising:
a processing chamber for removing unnecessary substances attached to the outer circumference portion of the substrate to be processed;
a rotary stage on which the substrate to be processed is placed having a smaller diameter than the diameter of the substrate to be processed;
a gas supply structure unit disposed to face an upper surface of the substrate to be processed;
a first gas supply system for supplying gas to the gas supply structure unit;
an atmospheric pressure microplasma source for supplying radicals for removing the unnecessary substances to the outer circumference portion of the substrate to be processed;
a second gas supply system for supplying gas to the atmospheric pressure microplasma source;
a high frequency power supply for supplying power to the atmospheric pressure microplasma source; and
a vacuum head for vacuuming and removing reaction products from the outer circumference portion of the substrate to be processed;
wherein the distance between a lower surface of the gas supply structure unit and the upper surface of the substrate to be processed is 2 mm or greater and 100 mm or smaller.

10. The bevel deposition removal apparatus according to claim 1, wherein said vacuum head is located between said rotary stage on which the substrate to be processed is placed and said atmospheric pressure microplasma source.

11. The bevel deposition removal apparatus according to claim 1, wherein said atmospheric pressure microplasma source is positioned such that radicals supplied therefrom are directed toward the outer circumferential portion of the substrate to be processed.

12. The bevel deposition removal apparatus according to claim 1, wherein said gas supply structure unit and said vacuum head are located such that gas supplied from said gas supply structure unit prevents diffusion of radicals to an inner area of the substrate.

13. The bevel deposition removal apparatus according to claim 12, wherein said gas supply structure unit and said vacuum head are located such that gas supplied from said gas supply structure unit flows in a direction from the inner area toward the outer circumference portion of the substrate to be processed, so as to prevent diffusion of radicals to the inner area of the substrate.

14. The bevel deposition removal apparatus according to claim 1, wherein the gas supply structure unit has openings for the gas, the openings being provided only at an outer circumference portion of the gas supply structure unit.

15. The bevel deposition removal apparatus according to claim 1, wherein said atmospheric pressure microplasma source includes a plurality of plasma heads for supplying said radicals.
